(19) United States
(12) Patent Application Publication
(10) Pub. No.: US 2013/0199379 A1
(43) Pub. Date: Aug. 8, 2013

(54) POD ADAPTER FOR USE WITH K-CUP™ BEVERAGE BREWER

(71) Applicant: Kienna Coffee USA, Inc., Phoenix, AZ (US)

(72) Inventor: LEONA ARNETT, Calgary (CA)

(73) Assignee: KIENNA COFFEE USA, INC., Phoenix, AZ (US)

(21) Appl. No.: 13/756,801

(22) Filed: Feb. 1, 2013

Related U.S. Application Data
(63) Continuation of application No. 61/593,642, filed on Feb. 1, 2012.

(51) Int. Cl. A47J 31/40

(52) U.S. Cl. CPC A47J 31/407
USPC 99/295

(57) ABSTRACT

This invention provides a K-cup™ pod adapter which an end-user can fill with substances of the user's own choosing as a filtered pod for brewing, such as specific coffee blends, specialty or other teas, or other brewable material, and then can insert and use the pod adapter instead of a pre-manufactured K-cup™, in a K-cup™ based beverage brewer such as those made by Keurig™.

### FIELD OF THE INVENTION

The present invention relates generally to extending the use of K-cup™ based beverage brewers by providing a pod adapter which an end-user can fill with substances for brewing of the user's own choosing, such as specific coffee blends, specialty or other teas, or other brewable material in suitable pod format, and then can insert and use the pod adapter instead of a pre-manufactured K-cup™

### BACKGROUND OF THE INVENTION

The prior art includes K-cup™-based systems such as the Keurig™ brewing systems, which together with the brewing equipment and manufacturing and packaging systems for coffees and teas, includes a system of K-cups™, which are pre-manufactured plastic packages filled with coffee, tea, or other materials suitable for brewing by infusion of water to make a beverage for an end-user. These systems provide packages which both hold the infusible material safely after manufacture for shipping and storage and distribution to end-user customer, but also act as a brewing or infusion chamber where water can be introduced by an associated brewing machine, held in the infusion chamber, and then disbursed from the infusion chamber into the user's cup or similar receptacle to be served.

The use of the K-cup™ of the Keurig™ and similar systems has several undesirable effects, among them: (1) the K-cups™ are not easily recycled, meaning the plastic and other components of the K-cups™ are used only once, and then become waste, requiring further handling and becoming a burden on society generally; and (2) the K-cups™ are only offered in certain flavours or beverages, restricting the end-users' ability to choose from a very broad range of other beverage types, by way of example such as locally roasted or specialty coffees or teas.

### SUMMARY OF THE INVENTION

To mitigate some of the problems with the prior art, this system provides for in a first aspect, the present invention provides a pod adapter for a Keurig™ or other K-cup™ compatible beverage brewing system comprising:
a. cup and a lid
b. the lid, optionally hinged to the cup, the lid with a central portion shaped to receive a water delivery mechanism of the brewing
c. the cup comprised of:
   i. a domed bottom with arched ribs radiating from an elevated central connection point connecting each rib, each rib being spaced from each adjacent rib by a void
   ii. each arched bottom rib's outer end joined with a side rib, the joints forming a base upon which the cup may sit, each side rib extending vertically and each side rib spaced from each adjacent side rib by a void
   iii. the top end of each side rib being attached to a ring, the ring forming the top of the cup, the ring having a connection to a hinge, where provided, for the lid
d. the voids designed to permit even flow of heated water from the brewer and desirable but limited expansion of the cup during brewing
e. the domed bottom to provide an elevated position to center and support materials placed in the cup for brewing
f. the cup to receive materials for brewing in the brewer to make a beverage

### BRIEF DESCRIPTION OF THE DRAWINGS

Embodiments of the present invention will now be described, by way of example only, with reference to the attached Figures, wherein:

FIG. 1 is top elevation of the invention, showing it with its lid hinged opened 180 degrees from its closed position.

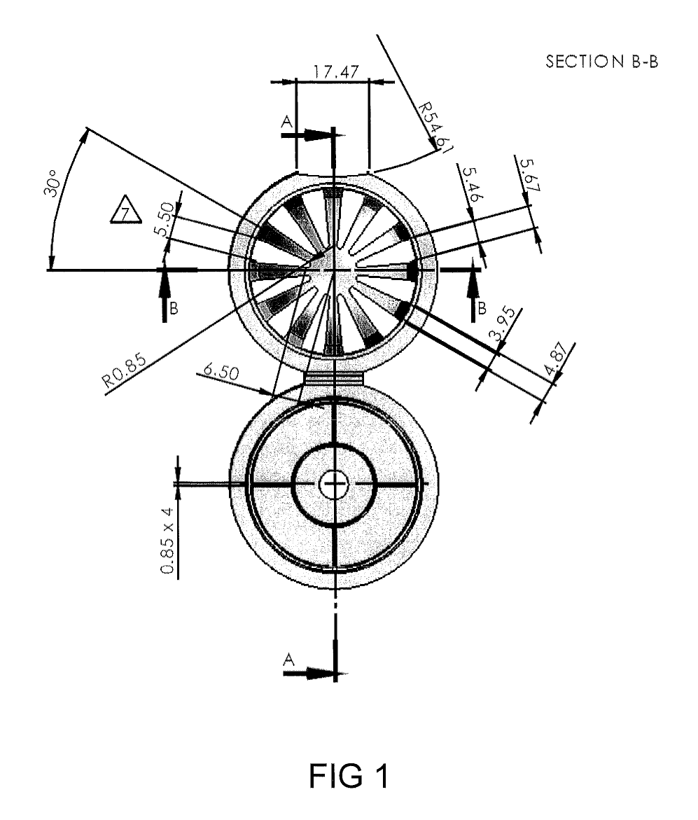

FIG. 2 is a cut-away perspective drawing of the device, cut along line A-A in FIG. 1, viewed from the cut-away to the inside of the device.

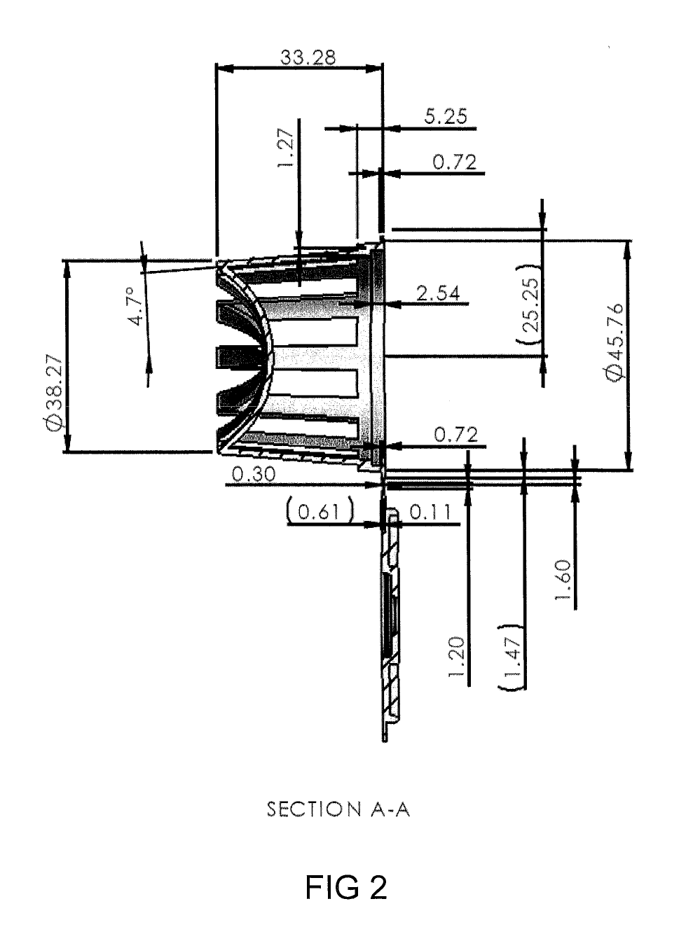

### DETAILED DESCRIPTION

Generally, the present invention provides a pod adapter which an end-user can fill with substances for brewing of the user's own choosing, such as specific coffee blends, specialty or other teas, or other brewable material, and then can insert and use the pod adapter instead of a pre-manufactured K-cup™.

There are a variety of different coffees which are packaged in filter material, such as those supplied by Wolfgang Puck, Melitta, Fratello, Reunion Island, Kienna™ and others, to permit single-cup brewed coffee. These single-cup coffee pods are essentially comprised of sufficient coffee in a packet surrounded by (and made of) a filter. They can be used in a number of ways to brew coffee. Customers like that they are disposable without having a great deal of inorganic or non-compostable materials, as well as that they provide a broad range of coffees and other beverages for brewing in a single-cup method.

A “pod” is a filter package containing roasted, ground coffee or other similar material for brewing into a beverage or flavored/scented fluid. Pods may be pre-packaged (such as by Wolfgang Puck, Melitta, Fratello, Reunion Island, Kienna™ or others), or may be assembled by an end-user using filter papers and special tools (such as “Perfect Pod”™, available at outlets such as www.perfectpodmaker.com).

The device is formed of a cup section 10 and a lid section 20 attached by a hinge 15 which can be a thinned portion of the body of the device. The device will typically be molded or shaped from one piece, and so have a unitized body. The lid 20 may be hinged 15 opened to fill or empty the inner chamber formed between arched bottom ribs 12, side ribs 14, top (about 16) and the lid 20 when closed. The chamber can be filled with a preconfigured pod of filtered coffee for use in a single-cup brewing system such as a Keurig™ coffee maker, replacing the Keurig™ K-cups™ ordinarily used, permitting a user to avoid discarding a plastic K-cups™ and permitting a user to use coffee not available in a premanufactured K-cup™ format.

The outer shape of the cup, provided by the outer surfaces of ribs 14, bottom intersection of ribs 14 and ribs 12, the outer surfaces of the top 16 and lid 20 is designed to fit into Keurig™ coffee brewing systems, and to accept these systems' water injection mechanism, typically a needle delivering hot water under pressure which pierces the lid of the K-cup™ to inject hot water into the enclosed coffee or tea or brewing material, at 21, while providing coffee within the cavity of the device for brewing and then release, without modification of the K-cup™ brewer. The domed bottom ribs 12 provide a means to elevate preformed filtered coffee pods into the region where the Keurig™ system delivers hot water under pressure, to optimize brewing and permit the needle to pierce the pod inserted by the user during use.

There is a need for the cavity defined (in part) by ribs 12 and 14 to expand to accommodate the expansion of coffee (or similar substances) in the cavity during brewing. The arched ribs 12, side ribs 14 and inter-rib spaces 13 and the flexibility of the materials chosen for the body of the device itself provide a capacity for this need to expand.

The combination of the ribs 14 and inter-rib spaces 13 plus the elevation of the coffee pod (or similar) by the domed ribs 12, places the coffee pod (or similar) at a position within the cavity of the device for optimal brewing when the Keurig™ system injects hot water, providing for an easy-to-use replacement for K-Cup™ supplies.

It will be apparent to those knowledgeable about beverage-making systems that the use of this invention can be applicable to a variety of hot beverages and adapted for systems other than the K-cup™ system.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A K-cup™ adapter for a Keurig™ or other K-cup™ compatible beverage brewing system comprising:
a. cup and a lid
b. the lid, optionally hinged to the cup but closable onto the cup, the lid with a central portion shaped to receive a water delivery mechanism of the brewing system
c. the cup comprised of:
i. a domed bottom with arched ribs radiating from an elevated central connection point connecting each rib, each rib being spaced from each adjacent rib by a void
ii. each arched bottom rib's outer end joined with a side rib, the joints forming a base upon which the cup may sit, each side rib extending vertically and each side rib spaced from each adjacent side rib by a void
iii. the top end of each side rib being attached to a ring, the ring forming the top of the cup, the ring having a connection for an optional hinge for the lid but capable of receiving and holding the lid when closed
d. the voids designed to permit even flow of heated water from the brewer and desirable but limited expansion of the cup during brewing
e. the domed bottom to provide an elevated position to center a pod of materials placed in the cup for brewing
f. the cup to receive a pod of materials for brewing in the brewer to make a beverage
